(19) United States
(12) Patent Application Publication
(10) Pub. No.: US 2001/0048548 A1
(43) Pub. Date: Dec. 6, 2001

(54) Optical pickup head with micro-mirror

(75) Inventor: Young Joo Yee, Kyonggl-do (KR)

Correspondence Address: Jonathan Y. Kang, Esq., Lee & Hong P.C., 11th Floor, 221 N. Figueroa Street, Los Angeles, CA, 90012-2601, US

(73) Assignee: LG Electronics, Inc.

(21) Appl. No.: 09/871,488

(22) Filed: May 30, 2001

(30) Foreign Application Priority Data
Jun. 2, 2000 (KR) 2000-30321

(51) Int. Cl. G02B 1/00

(52) U.S. Cl. 359/362

(57) ABSTRACT

Optical pickup head which makes a fine movement by a driver, and focuses an incident laser beam to a recording medium for recording/reproducing a data, including a micro mirror having at least one 45° mirror surface for reflecting the incident laser beam perpendicular to an incident direction, a focusing lens under the micro mirror for primary focusing of the laser beam reflected at the micro mirror, and an SIL (Solid Immersion Lens) under the focusing lens for secondary focusing of the laser beam focused primarily, thereby permitting fast and high precision data search.

### BACKGROUND OF THE INVENTION

1. Field of the Invention

The present invention relates to optical information devices, and more particularly, to an optical pickup head with a micro-mirror for changing an optical path of a light.

2. Background of the Related Art

Since the optical information storage device can implement a high density information capacity, it is a recent trend that the optical information storage device is under active research and rapidly is put into commercial use. The optical information storage device has advantages of a fast response, a non-contact pickup, and handy to carry, and most of all, the optical information storage device can compact data to a high density into a range of a wavelength of a laser beam for recording and reproduction. In order to reduce a data bit size for recording and reproduction of optical information, either a beam of short wave length is used, or aberration of an optical system is made great. Particularly, as a technology for overcoming a diffraction limit of a beam by making an aberration greater, a method of using SIL (Solid Immersion Lens) is suggested.

A related art optical information storage device employs a method, in which an optical system having a laser diode, collimator lenses, an optical splitter, and the like, and an optical pickup head having an objective lens, are assembled, and are moved together for recording and reproducing optical information.

However, since a size of data bit, and a pitch between data tracks are reduced as the information density increases, the related art optical pickup head becomes to have a poor tracking accuracy as well as a significant drop of a tracking speed due to an excessive weight of the optical pickup head.

### SUMMARY OF THE INVENTION

Accordingly, the present invention is directed to an optical pickup head that substantially obviates one or more of the problems due to limitations and disadvantages of the related art.

An object of the present invention is to provide an optical pickup head, of which weight is minimized for enhancing tracking accuracy and speed.

Another object of the present invention is to provide an optical pickup head, which can change an optical path, precisely.

Further object of the present invention is to provide an optical pickup head, which can reduce an alignment error of a mirror angle.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the optical pickup head which makes a fine movement by a driver, and focuses an incident laser beam to a recording medium for recording/reproducing a data, includes a micro mirror having at least one 45° mirror surface for reflecting the incident laser beam perpendicular to an incident direction, a focusing lens under the micro mirror for primary focusing of the laser beam reflected at the micro mirror, and an SIL (Solid Immersion Lens) under the focusing lens for secondary focusing of the laser beam focused primarily.

The 45° mirror surface of the micro mirror has a highly reflective metal coating applied thereto, and the micro mirror is formed of a silicon substrate.

The silicon substrate is a 9.74° off-axis (100) silicon wafer.

The 45° mirror surface of the micro-mirror is formed by anisotropic etching by using one etchant selected from KOH, EDP, TMAH, and the 45° mirror surface of the micro-mirror, a focus plane of the focusing lens, and a focus plane of the SIL are aligned in parallel.

In another aspect of the present invention, there is provided an optical pickup head which makes a fine movement by a driver, and focuses an incident laser beam to a recording medium for recording/reproducing a data, including a micro mirror having at least one 45° mirror surface for reflecting the incident laser beam perpendicular to an incident direction, a focusing lens under the micro mirror for primary focusing of the laser beam reflected at the micro mirror, a first supporting frame fitted under the micro-mirror for supporting the focusing lens, an SIL (Solid Immersion Lens) under the focusing lens for secondary focusing of the laser beam focused primarily, and a second supporting frame fitted under the first supporting frame for supporting the SIL.

In further aspect of the present invention, there is provided 13. An optical pickup head which makes a fine movement by a driver, and focuses an incident laser beam to a recording medium for recording/reproducing a data, including a micro mirror having at least one 45° mirror surface for reflecting the incident laser beam perpendicular to an incident direction, a focusing lens under the micro mirror for primary focusing of the laser beam reflected at the micro mirror, a first supporting frame fitted under the micro-mirror having an opening in a region for supporting the focusing lens, an SIL (Solid Immersion Lens) under the focusing lens for secondary focusing of the laser beam focused primarily, a second supporting frame fitted under the first supporting frame having an opening in a region for supporting the SIL, and an air-bearing surface formed under the second supporting frame for making the second supporting frame buoyant.

The opening has a side surface sloped at a fixed angle such that an upper width thereof is greater than a lower width thereof.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a perspective view of an optical pickup head in accordance with a preferred embodiment of the present invention;

FIG. 2 illustrates a perspective view of a micro-mirror integrated with an optical pickup of the present invention;

FIG. 3 illustrates a perspective view of a silicon wafer for fabricating the micro-mirror in FIG. 2;

FIG. 4 illustrates a section of a micro-mirror with a 45° mirror surface obtained by etching a 9.74° off-axis (100) silicon wafer in FIG. 3;

FIGS. 5A˜5F illustrate sections showing the steps of a method for fabricating a micro-mirror with a 45° mirror surface; and,

FIG. 6 illustrates an optical system of an optical information storage device of the optical pickup head of the present invention, schematically.

### DETAILED DESCRIPTION OF THE PREFERRED EMBODIMENT

Reference will now be made in detail to the preferred embodiments of the present invention, examples of which are illustrated in the accompanying drawings.

The present invention suggests reducing a size of a 45° mirror which deflects a laser beam to a near field optical pickup head, and integrating the reduced size micro-mirror with to the near field optical pickup head, for reducing weight of the movable optical pickup head, thereby enhancing tracking speed and accuracy.

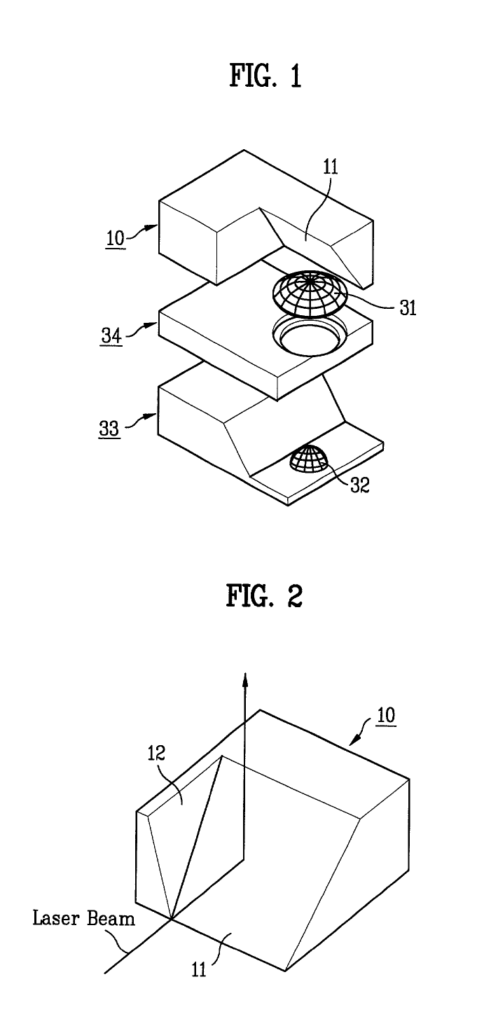

FIG. 1 illustrates a perspective view of an optical pickup head in accordance with a preferred embodiment of the present invention.

Referring to FIG. 1, the optical pickup head in accordance with a preferred embodiment of the present invention includes a micro-mirror 10 with a 45° mirror surface 11 for reflecting a laser beam by 90° with respect to an incident direction, a focusing lens 31 under the micro-mirror for a primary focusing of the laser beam reflected at the micro-mirror 10, and an SIL (Solid Immersion Lens) 32 under the focusing lens 31 for focusing the laser beam focused, primarily.

As shown in FIG. 2, though the micro-mirror 10 only has the 45° mirror surface 11, the micro-mirror may have a plurality of mirror surfaces. Though not shown, the 45° mirror surface 11 of the micro-mirror may have a coat of a highly reflective metal applied thereto for enhancing a reflective efficiency of the laser beam.

As shown in FIG. 1, the 45° mirror surface 11 of the micro-mirror, a focus plane of the focusing lens, and a focus plane of the SIL are aligned in parallel, for providing an optical axis in a direction perpendicular to a surface of an optical disk to/from which a data is recorded/reproduced. In FIG. 1, there is a first supporting frame 34 under the micro-mirror 10 having an opening for supporting the focusing lens 31, and a second supporting frame 33 under the first supporting frame 34 having an opening for supporting the SIL 32. Each of the openings of the first and second supporting frames 34 and 33 has a sloped side at a fixed angle such that an upper width is larger than a lower width. The SIL 32 is fitted in the opening of the second supporting frame 33.

There is an air-bearing surface (not shown) for floating the second supporting frame 33 under a bottom surface of the second supporting frame 33. The air-bearing surface keeps the optical pickup head floated by a fluid dynamic air buoyancy for maintaining a near field gap from a surface of the optical disk, when minimizing weight of the optical head floated by the air-bearing surface is an important parameter in adjustment of the near field gap. Therefore, in the present invention, it is very important to minimize a size of the micro-mirror integrated to the optical pickup.

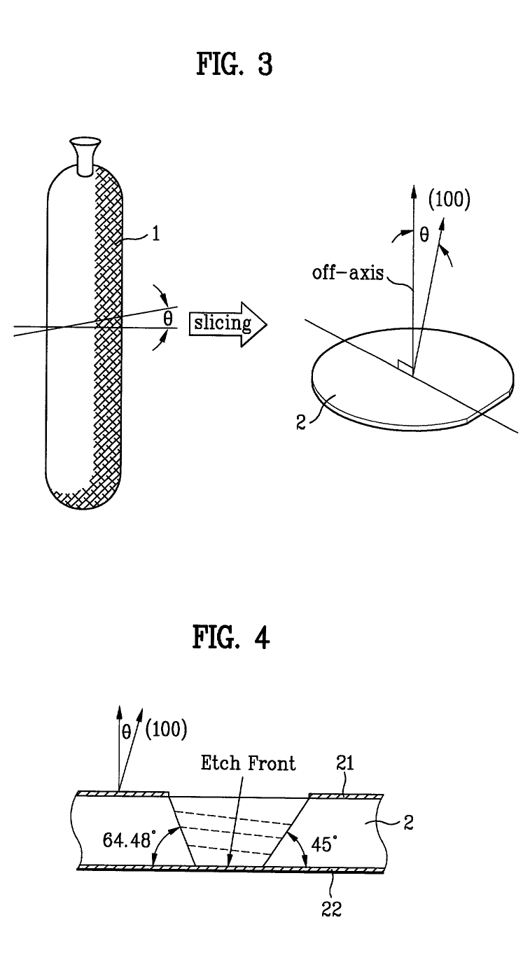

The present invention suggests using a 9.74° off-axis (100) silicon wafer for fabricating the micro-mirror smaller. FIG. 3 illustrates a perspective view of a silicon wafer for fabricating the micro-mirror in FIG. 2, and FIG. 4 illustrates a section of a micro-mirror with a 45° mirror surface obtained by etching the 9.74° off-axis (100) silicon wafer in FIG. 3.

Referring to FIGS. 3 and 4, the micro-mirror 10 of the present invention is formed of a silicon wafer at 9.74° off-axis with respect to (100) crystal orientation. In general, the 9.74° off-axis (100) silicon wafer is provided by slicing a single crystal silicon ingot 1, prepared by the CZ (Czchralski) method, or FZ (Floating Zone) method, at a fixed angle of 9.74° with respect to a plane perpendicular to an axis of the silicon ingot 1 that is a direction of a silicon growth, and mirror polishing the sliced surface.

As shown in FIG. 4, upon subjecting the 9.74° off-axis (100) silicon wafer 2 provided thus to wet etching by using KOH, EDP (Ethylene diamine pyrocatechol), TMAH (Tetramethyle Ammonium Hydroxide), and the like, which are anisotropic etching solutions, opposite surfaces at 45° and at 64.48° to an {111 } silicon crystal plane of the off-axis silicon wafer respectively are appeared. In general, since a silicon anisotropic etching solution has an etching rate on the {111 } silicon crystal plane significantly lower than other silicon crystal planes, an etch stop is occurred at the {111 } silicon crystal plane. If a (100) silicon wafer is used, the angle of the {111} silicon crystal plane formed by the etch stop is 54.74° with respect to the (100) silicon wafer surface. Therefore, by subjecting an off-axis silicon wafer 2 sliced with the axis tilted by 9.74° to anisotropic etching, a {111 } crystal surface at 45° to a surface of the off-axis silicon wafer 2 can be obtained. Since a surface roughness of the {111 } silicon crystal surface obtained thus is smooth enough to use as a mirror surface, the surface is used as a mirror surface. If it is desired to enhance a reflective efficiency, a coat of a highly reflective metal may be applied to a finished 45° surface.

As shown in FIG. 4, formation of the 45° mirror surface is achieved by an automatic etch stop, and a size of the micro-mirror itself is fixed by a pattern size of a front etch mask thin film 21 and a thickness of the off-axis silicon wafer 2. Therefore, the size and form of the micro-mirror can be controlled precisely by a photolithography in a semiconductor fabrication process.

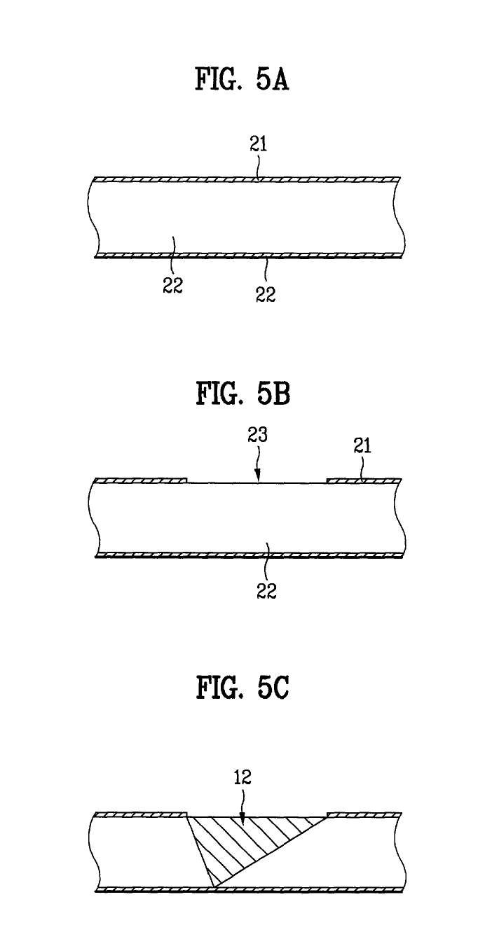

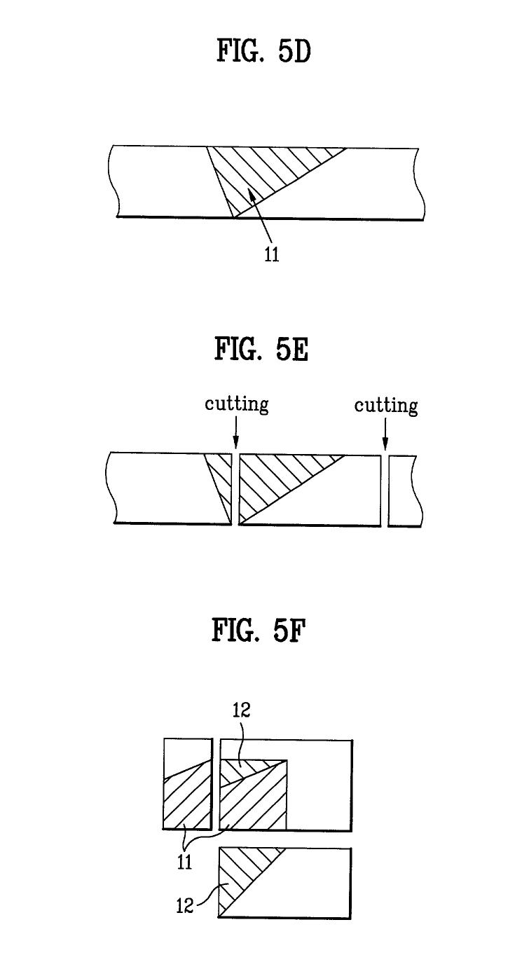

FIGS. 5A˜5F illustrate sections showing the steps of a method for fabricating a micro-mirror with a 45° mirror surface.

Referring to FIG. 5A, an etch mask 21 or 22 is formed on each of a front and a rear surfaces of a 9.74° off-axis silicon wafer 2 by deposition, oxidation, or plating. The etch masks 21 and 22 may be formed of a silicon nitride, a silicon oxide, or a metal thin film, selectively.

Then, referring to FIG. 5B, an etch window 23 is formed in the etch mask 21 to expose the silicon wafer 2 by photolithography, to expose the silicon wafer 2.

Referring to FIG. 5C, the exposed silicon wafer 2 is dipped in a silicon anisotropic etching solution, such as KOH, EDP, TMAH, and the like, and heated to an appropriate temperature, for wet etching of the silicon wafer 2. In this instance, the etching is stopped at an {111 } crystal plane of a single crystal silicon to form a wall surface of a sloped silicon wafer 2.

Thus, after the anisotropic etching is carried out to a depth as much as required until the 45° mirror surface is formed, as shown in FIG. 5D, a remained etch masks 21 and 22 are removed. In this instance, one out of four crystal surface formed on the silicon wafer has the 45° slope to the silicon wafer surface, which is used as the mirror surface 11.

Then, as shown in FIG. 5E, the silicon wafer 2 is cut to include the 45° mirror surface 11, to complete formation of a micro-mirror.

FIG. 5F illustrates plan, side, and front views of the micro-mirror cut in a chip form.

Referring to FIGS. 5F and 2, the sloped wall surface 12 of the fabricated micro-mirror can be removed as necessary, and dimensions of parts except the 45° mirror surface 11 can also be adjusted as required by an optical system to which this micro mirror is to be applied.

In order to enhance a reflectivity of the micro-mirror, a coat of highly reflective metal, or the like, may be deposited on the 45° mirror surface 11.

Upon application of the micro-mirror fabricated in a micro-size and -weight to the optical pickup head, the optical pickup head can track a data accurately at a high speed.

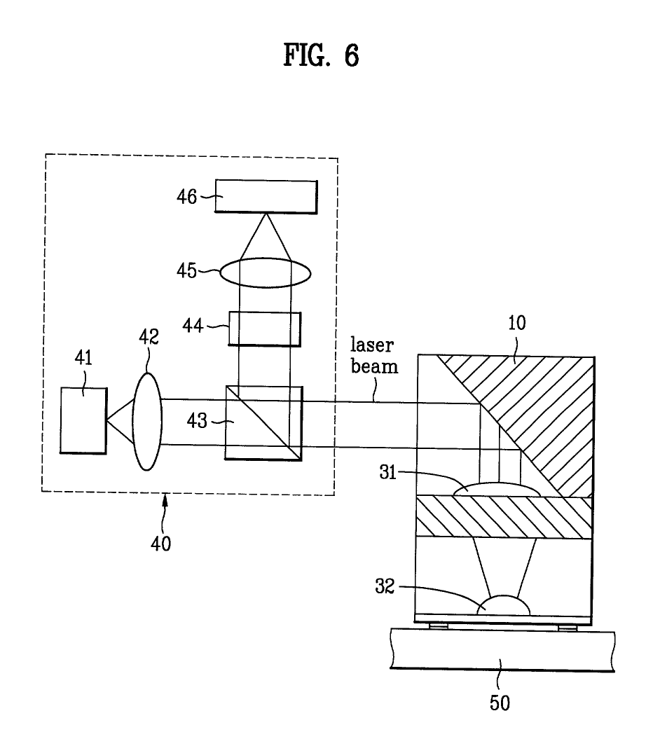

FIG. 6 illustrates an optical system of an optical information storage device of the optical pickup head of the present invention, schematically.

Referring to FIG. 6, a laser beam emitted from a laser source 41, such as a laser diode, is collimated by a collimator 42, and passes through a beam splitter 43. Then, the laser beam is reflected at a 45° mirror surface of the micro-mirror 10 integrated to a near field optical pickup head, to have its path deflected toward a focusing lens 31. The laser beam is focused onto an SIL 32 by the focusing lens 31 primarily, and is focused by the SIL 32 secondarily to form a near field beam. The near field beam is directed to a recording layer of the optical disk 50 through a near field gap, to record or reproduce a data.

In a case a data recorded on a recording layer of the optical disk 50 is reproduced, a portion of incident beam reflected at the recording layer of the optical disk 50 reverses an optical path to be reflected at the micro-mirror after the incident beam passes through the SIL 32, and the focusing lens 31, to return to a fixed optical system 40, wherein the beam is incident to an analyzer 44, and reaches to a beam detector through a focusing lens 45, where an optical signal is detected, thereby making an optical information signal distinctive.

Thus, the present invention can provide a pickup head for an extra high density optical information storage device, which can record or reproduce a data to/from the optical disk at a recording density higher than several ten giga bytes per a square inch.

The reduction of a total weight of an optical pickup head by fabrication of micro-mirror and integration of the micro-mirror to an optical pickup head facilitates a fast data search and a high precision tracking because the weight reduction enhances a tracking preciseness and speed of the optical pickup head, permits a precise change of an optical path, and reduces an alignment error of a mirror angle.

It will be apparent to those skilled in the art that various modifications and variations can be made in an optical pickup head of the present invention without departing from the spirit or scope of the invention. Thus, it is intended that the present invention cover the modifications and variations of this invention provided they come within the scope of the appended claims and their equivalents.

What is claimed is:

1. An optical pickup head which makes a fine movement by a driver, and focuses an incident laser beam to a recording medium for recording/reproducing a data, the optical pickup head comprising:
a micro mirror having at least one 45° mirror surface for reflecting the incident laser beam perpendicular to an incident direction;
a focusing lens under the micro mirror for primary focusing of the laser beam reflected at the micro mirror; and,
an SIL (Solid Immersion Lens) under the focusing lens for secondary focusing of the laser beam focused primarily.

2. An optical pickup head as claimed in claim 1, wherein the 45° mirror surface of the micro mirror has a highly reflective metal coating applied thereto.

3. An optical pickup head as claimed in claim 1, wherein the micro mirror is formed of a silicon substrate.

4. An optical pickup head as claimed in claim 3, wherein the silicon substrate is a 9.74° off-axis (100) silicon wafer.

5. An optical pickup head as claimed in claim 1, wherein the 45° mirror surface of the micro-mirror is formed by anisotropic etching by using one etchant selected from KOH, EDP, TMAH.

6. An optical pickup head as claimed in claim 1, wherein the 45° mirror surface of the micro-mirror, a focus plane of the focusing lens, and a focus plane of the SIL are aligned in parallel.

7. An optical pickup head which makes a fine movement by a driver, and focuses an incident laser beam to a recording medium for recording/reproducing a data, the optical pickup head comprising:
a micro mirror having at least one 45° mirror surface for reflecting the incident laser beam perpendicular to an incident direction;
a focusing lens under the micro mirror for primary focusing of the laser beam reflected at the micro mirror;
a first supporting frame fitted under the micro-mirror for supporting the focusing lens;
an SIL (Solid Immersion Lens) under the focusing lens for secondary focusing of the laser beam focused primarily; and,
a second supporting frame fitted under the first supporting frame for supporting the SIL.

8. An optical pickup head as claimed in claim 7, wherein the 45° mirror surface of the micro mirror has a highly reflective metal coating applied thereto.

9. An optical pickup head as claimed in claim 7, wherein the micro mirror is formed of a silicon substrate.

10. An optical pickup head as claimed in claim 9, wherein the silicon substrate is a 9.74° off-axis (100) silicon wafer.

11. An optical pickup head as claimed in claim 7, wherein the 45° mirror surface of the micro-mirror is formed by anisotropic etching by using one etchant selected from KOH, EDP, TMAH.

12. An optical pickup head as claimed in claim 7, wherein the 45° mirror surface of the micro-mirror, a focus plane of the focusing lens, and a focus plane of the SIL are aligned in parallel.

13. An optical pickup head which makes a fine movement by a driver, and focuses an incident laser beam to a recording medium for recording/reproducing a data, the optical pickup head comprising:
a micro mirror having at least one 45° mirror surface for reflecting the incident laser beam perpendicular to an incident direction;
a focusing lens under the micro mirror for primary focusing of the laser beam reflected at the micro mirror;
a first supporting frame fitted under the micro-mirror having an opening in a region for supporting the focusing lens;
an SIL (Solid Immersion Lens) under the focusing lens for secondary focusing of the laser beam focused primarily;
a second supporting frame fitted under the first supporting frame having an opening in a region for supporting the SIL; and,
an air-bearing surface formed under the second supporting frame for making the second supporting frame buoyant.

14. An optical pickup head as claimed in claim 13, wherein the 45° mirror surface of the micro mirror has a highly reflective metal coating applied thereto.

15. An optical pickup head as claimed in claim 13, wherein the micro mirror is formed of a silicon substrate.

16. An optical pickup head as claimed in claim 15, wherein the silicon substrate is a 9.74° off-axis (100) silicon wafer.

17. An optical pickup head as claimed in claim 13, wherein the 45° mirror surface of the micro-mirror is formed by anisotropic etching by using one etchant selected from KOH, EDP, TMAH.

18. An optical pickup head as claimed in claim 13, wherein the 45° mirror surface of the micro-mirror, a focus plane of the focusing lens, and a focus plane of the SIL are aligned in parallel.

19. An optical pickup head as claimed in claim 13, wherein the opening has a side surface sloped at a fixed angle such that an upper width thereof is greater than a lower width thereof.

20. An optical pickup head as claimed in claim 13, wherein the SIL is fitted in the opening of the second supporting frame.
